(19) United States
(12) Patent Application Publication
(10) Pub. No.: US 2025/0290946 A1
(43) Pub. Date: Sep. 18, 2025

(54) OPTOMECHANICAL ACCELEROMETER SYSTEMS AND METHODS

(71) Applicant: Purdue Research Foundation, West Lafayette, IN (US)

(72) Inventors: Sunil Ashok Bhave, West Lafayette, IN (US); Hao Tian, Pasadena, CA (US)

(73) Assignee: Purdue Research Foundation, West Lafayette, IN (US)

(21) Appl. No.: 19/228,357

(22) Filed: Jun. 4, 2025

Related U.S. Application Data
(63) Continuation of application No. PCT/US2023/082600, filed on Dec. 5, 2023.
(60) Provisional application No. 63/430,724, filed on Dec. 7, 2022.

(51) Int. Cl. G01P 15/093; G01P 15/08

(52) U.S. Cl. CPC G01P 15/093; G01P 15/0802

(57) ABSTRACT

An optomechanical accelerometer includes an optical ring resonator, a proof mass, and one or more springs coupling the proof mass with the optical ring resonator. The ring resonator defines a perpendicular axis centrally therethrough and an optical resonant frequency. The proof mass is movable along the perpendicular axis. The one or more springs are configured to selectively stretch or contract when the proof mass is mechanically displaced along the perpendicular axis to generate stress or strain on the first ring resonator. Mechanical displacement of the proof mass is operable to modify the optical resonant frequency of the first ring resonator.

### CROSS-REFERENCE TO RELATED APPLICATIONS

This application is a continuation of International Application No. PCT/US2023/082,600, entitled “Optomechanical Accelerometer Systems and Methods,” filed Dec. 5, 2023, and is related to and claims the priority benefit of U.S. Provisional Patent Application No. 63/430,724, entitled “Optomechanical Accelerometer Systems and Methods,” filed Dec. 7, 2022, the contents both of which are hereby incorporated by reference in their entirety into the present disclosure.

### TECHNICAL FIELD

The present disclosure in general relates to measuring acceleration and, more particularly, the present disclosure relates to optomechanical accelerometers for measuring acceleration using silicon nitride optical ring resonators.

### BACKGROUND

This section introduces aspects that may help facilitate a better understanding of the disclosure. Accordingly, these statements are to be read in this light and are not to be understood as admissions about what is or is not prior art.

The monitoring of accelerations is essential for a variety of applications ranging from inertial navigation to consumer electronics. The basic operation principle of an accelerometer is to measure the displacement of a flexibly mounted test mass. Sensitive displacement measurement may be realized using capacitive, piezo-electric, tunnel-current, or optical techniques. While optical readout provides superior displacement resolution and resilience to electromagnetic interference, conventional optical accelerometers face several drawbacks. For example, conventional free-space optical accelerometers do not allow for large scale production or chip-scale integration, and they often involve bulky test masses. Thus, improvements to integrated optics-based accelerometers are needed.

### SUMMARY

Described herein are systems and methods related to integrated optomechanical accelerometers that are based on or include one or more silicon nitride photonic micro-ring resonators. Specifically, the present disclosure includes aspects which can include a first ring resonator defining a perpendicular axis centrally therethrough, a proof mass movable along the perpendicular axis, and one or more springs coupling the proof mass with the first ring resonator. Further, the first ring resonator can define an optical resonant frequency. Still further, the one or more springs can be configured to selectively stretch or contract when the proof mass is mechanically displaced along the perpendicular axis to generate stress or strain adjacent to the first ring resonator. Mechanical displacement of the proof mass can be operable to modify the optical resonant frequency of the first ring resonator.

In other aspects of the disclosure, a method of fabricating an accelerometer can include depositing a photonic layer over a silicon material layer, etching a pattern within the photonic layer, etching the pattern deeper through a portion of the silicon material layer to form a trench, polishing a backside surface of the silicon material layer, and isotropically etching the silicon material layer. Additional steps can include, among others, embedding an optical waveguide within the photonic layer, or bonding the backside surface of one component of the two unattached components to a spacer to thereby suspend a proof mass.

This summary is provided to introduce a selection of the concepts that are described further in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1A depicts an upper elevational view of an exemplary optomechanical accelerometer, showing a suspended proof mass of the optomechanical accelerometer, and showing via a dashed line an approximate positioning of the embedded optical waveguide within the anchor of the optomechanical accelerometer;

FIG. 1B depicts a lower elevational view of the optomechanical accelerometer of FIG. 1A;

FIG. 1C depicts a cross-sectional view of the accelerometer of FIG. 1A, showing the embedded optical waveguide;

FIG. 1D depicts a schematic showing the transduction from optical resonance shifting to output light intensity modulation by biasing a laser at the slope of the optical resonance of the accelerometer of FIG. 1A;

FIG. 1E depicts a graphical output chart showing a numerical simulation of radial stress (σᵣ) under one gravity of the cross-section portion highlighted in the dashed box shown in FIG. 1B;

FIG. 2A depicts a schematic diagram of one example layout of a chip having four optical resonators, showing half of the devices being released and the other half being unreleased;

FIG. 2B depicts an image of an example of a fully packaged chip including the resonator layout of FIG. 2A;

FIG. 2C depicts an optical microscope image of one released device, showing one example of dimensions being labeled, and showing an enlarged portion for clarity;

FIG. 3 depicts a graphical plot of an optical transmission spectrum of one of the optical resonances at around 1550 nanometers, showing the experimental data (solid lines) being fitted with a Lorentz function (dashed lines), with the optical linewidth being 47 MHz corresponding to an optical Q of 4 million;

FIG. 4 depicts a series of schematics representative of one exemplary fabrication method for an optomechanical accelerometer;

FIG. 5 depicts a block diagram of the one example optical accelerometer measurement system;

FIG. 6 depicts a set of graphical plots showing measured output voltage signals from both the DUT and ADXL (top) and calibrated sensitivity of the DUT referenced to the ADXL (bottom);

FIG. 7 depicts a set of graphical plots showing measured noise spectrum of the DUT and ADXL when the drive of the shaker table is off, along with the noise of the DUT when the laser is biased far off the optical resonance (top), and also showing the calculated resolution of the optomechanical accelerometer (bottom);

FIG. 8 depicts a schematic showing an accelerometer system driven by an integrated distributed feedback laser (e.g., a self-injected semiconductor laser, or “SIL”), including a piezoelectric actuator for tuning the frequency of the laser;

FIG. 9 depicts a schematic showing another accelerometer system driven by heterodyne detection utilizing two SIL lasers, the acceleration being detected by measuring the frequency difference between the two SIL lasers;

FIG. 10 depicts a schematic showing another accelerometer system driven by heterodyne detection via Pound-Drever-Hall (PDH) locking, showing one of the lasers locked to the released accelerometer through PDH locking, the acceleration being detected by measuring the frequency difference between the two lasers; and

FIG. 11 depicts a schematic showing another accelerometer system driven by heterodyne detection having a dual closed loop configuration.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown, or the precise experimental arrangements used to arrive at the various graphical results shown in the drawings.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Reference systems that may be used herein can refer generally to various directions (for example, upper, lower, forward and rearward), which are merely offered to assist the reader in understanding the various embodiments of the disclosure and are not to be interpreted as limiting. Other reference systems may be used to describe various embodiments, such as those where directions are referenced to the portions of the device, for example, toward or away from a particular element, or in relations to the structure generally (for example, inwardly or outwardly).

Due to the maturity of the microelectromechanical systems (MEMS) technologies, the chip-scale accelerometer has become the workhorse for today's inertial sensing systems, and found a widespread application including navigation systems, self-driving cars, virtual reality (VR), as well as video game controllers. Moreover, using an array of accelerometers for detecting dark matters has drawn much attention recently. For traditional accelerometers, the acceleration is sensed by measuring the displacement of a movable mechanical proof mass capacitively or piezoelectrically, where the displacement x is related with the acceleration a via x(ω)=χ(ω)a(ω), where χ⁻¹(ω)=ω²−ω²+i[ωωₘ/Qₘ] is the mechanical susceptibility, ωₘ is the angular frequency of the first mechanical mode of the proof mass.

Recently, optical detection of the acceleration and displacement has been intensively studied due to its ultra-high sensitivity and low noise approaching the standard quantum limit (SQL). One example is the success of detection of gravitational wave using Laser Interferometer Gravitational-Wave Observatory (LIGO). Different from the electromechanical accelerometer, the optical detection allows remote sensing where the information can be transmitted through the fiber. Moreover, there is no metal in optical sensors which enables detection in harsh environments. While research towards chip-scale integration of optomechanical accelerometers has made progress, existing optomechanical accelerometers still rely on free space optical cavities. These accelerometers have to be hand assembled which presents challenges for large-scale production and integration.

Although some optomechanical accelerometers utilize integrated photonic crystal structures, the proof mass is limited to μg, with higher thermal Brownian noise, which is related with the mass as:

$${a}_{th} = \sqrt{\frac{4 {k}_{B} T {ω}_{m}}{{mQ}_{m}}}$$

where k_{B} is Boltzmann constant, T is the temperature, m is the mass, and Qₘ is the quality factor of the mechanical fundamental mode. From the expression, it can be understood that the larger the mass, the smaller the thermal noise. Also, for larger mass, the mechanical resonant frequency will be smaller which also leads to smaller aₜₕ.

Described herein are systems and methods related to integrated optomechanical accelerometers that are based on or include one or more ring resonators, for example, silicon nitride (Si₃N₄)-based photonic micro-ring resonators. In the embodiments described, a proof mass may be suspended at the center, which generates stress around the waveguide and alters the resonant frequency of the optical micro-ring resonator upon being exposed to the external acceleration. By biasing a laser at the slope of the optical resonance, that acceleration caused by the proof mass can be measured by detecting the modulation of the output light intensity from the micro-ring resonator.

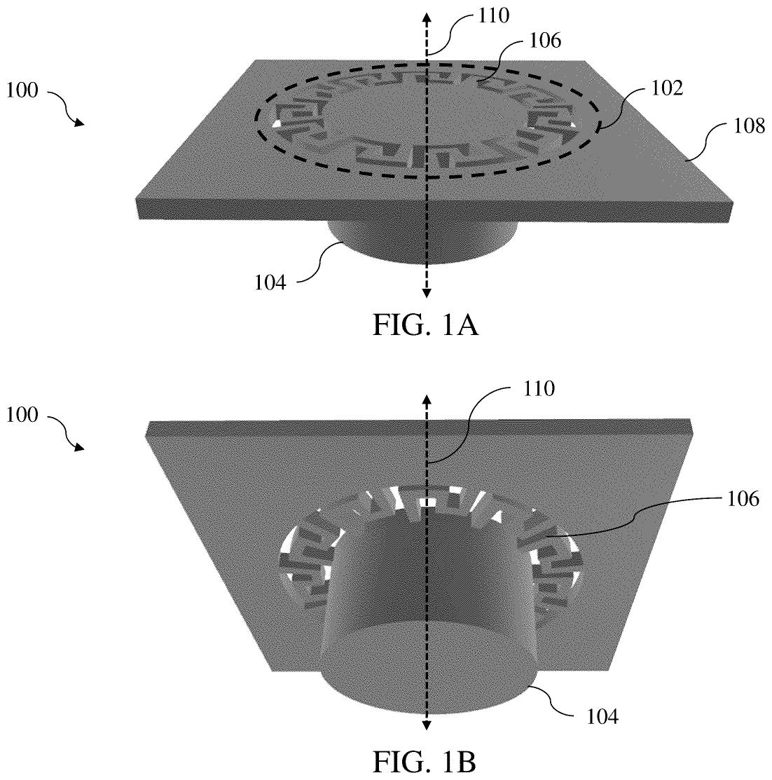

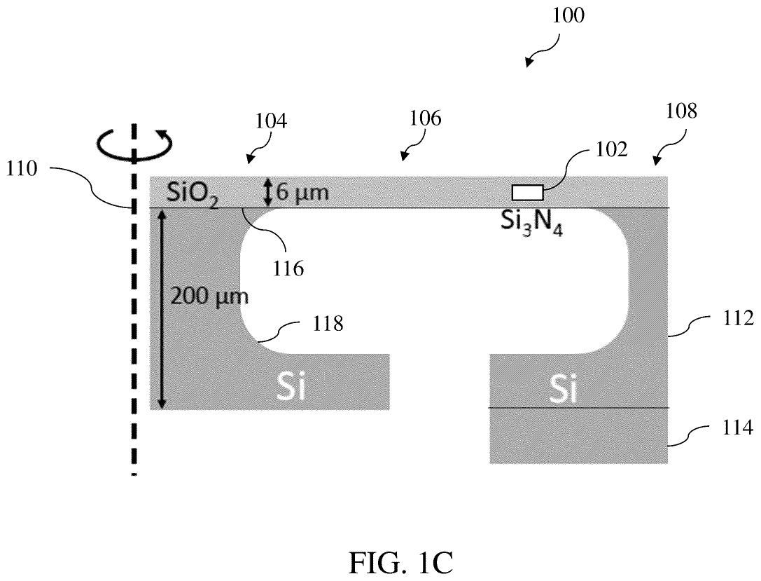

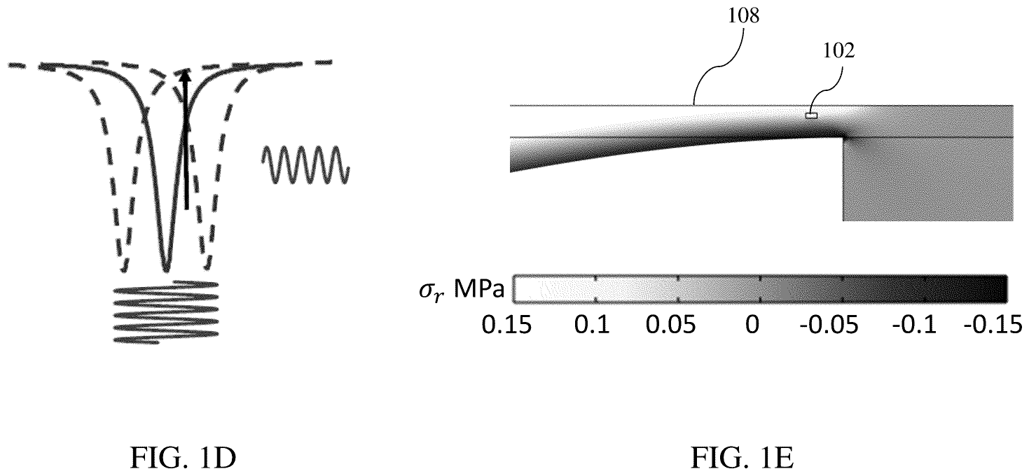

More particularly, FIGS. 1A-1B depict one exemplary embodiment of an optomechanical accelerometer (100) that includes an optical waveguide, shown as micro-ring resonator (102), embedded within (shown as a dashed line). In some embodiments, the optical micro-ring resonator (102) may include or otherwise be formed out of silicon nitride (Si₃N₄). While one particular embodiment of an optomechanical accelerometer is described, it should be understood that certain aspects and parameters of the optomechanical accelerometer may be altered depending on the particular application without deviating from the overall construction and design that is described.

More particularly, schematics and a cross-sectional view of one example optomechanical accelerometer (100) are shown in FIGS. 1A-1C. The center proof mass (104) is suspended and supported by a series of 6-μm-thick oxide springs (106) that are connected to the anchor portion (108) of the accelerometer (100). A Si₃N₄ optical micro-ring resonator (102) is embedded in an oxide material layer forming the supporting springs (108) (see, FIG. 1C). Under vertical acceleration, the proof mass (104) will experience mechanical displacement vertically (i.e., in a direction along axis (110)). The displacement of the proof mass (104) generates stress and strain around the micro-ring resonator (102) as simulated in FIG. 1E, which changes the effective refractive index of the micro-ring resonator (102) through photoelastic and moving boundary effects. This will modify the effective length of the optical cavity of the micro-ring resonator (102) and thus the optical resonant frequency of the micro-ring resonator (102). As illustrated in FIG. 1D, by biasing a light source (e.g., a laser) at the slope of the optical resonance, the shifting of the resonance will modulate the output light intensity which can be measured by a low-noise photodetector. In this way, the displacement of the proof mass (104) and the acceleration can be sensed by monitoring the output light intensity from the accelerometer (100).

Further shown in FIG. 1C are additional material layers of the accelerometer (100) which may be included. For example, a silicon layer (112) may be formed to couple with the supporting spring (108), and an additional spacer layer (114) may be coupled with the silicon layer (112) to provide space for the proof mass (104) (which may be formed of a silicon oxide layer (116) over a silicon layer (118)) to displace vertically.

For certain applications, the micro-ring resonator (102) can have a radius of 1.5 mm and a free spectrum range (FSR) of 15 gigahertz (GHz). The proof mass (104) can be around 1.6 milligrams (mg) and the first mechanical mode at around 1.5 kilohertz (kHz). The thermal noise at room temperature can be 100 ng/√Hz (1 g=9.8 m/s²). The sensitivity and resolution of the optomechanical accelerometer (100) can be characterized with a shaker table and it is calibrated by referencing to a commercial Analog Devices accelerometer (ADXL). An upper resolution for the current device may be around 500 ng/√Hz at the mechanical resonance, which is comparable to state-of-the-art optomechanical accelerometers having free-space optical cavities.

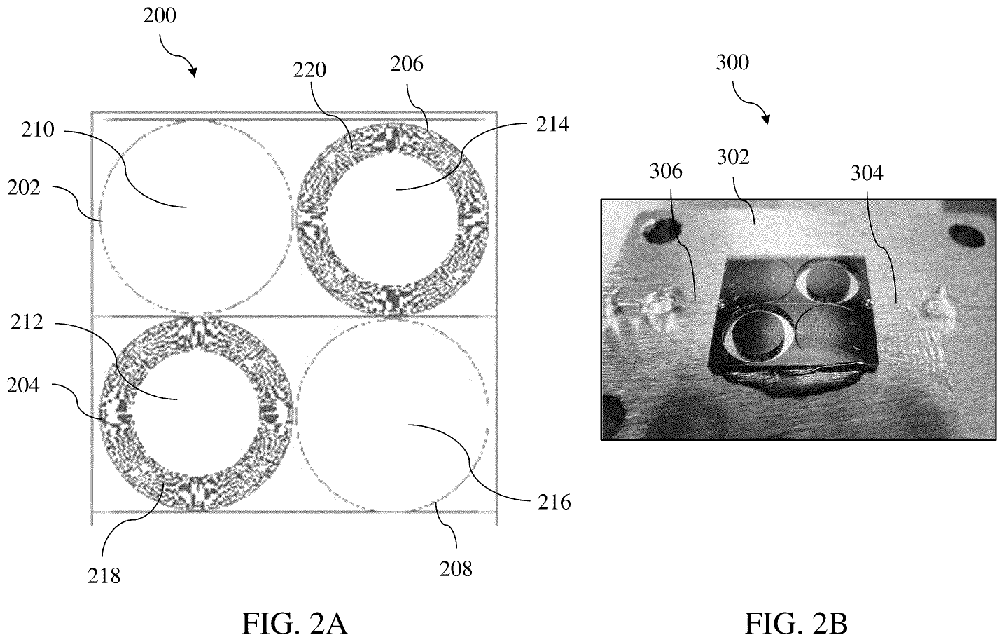

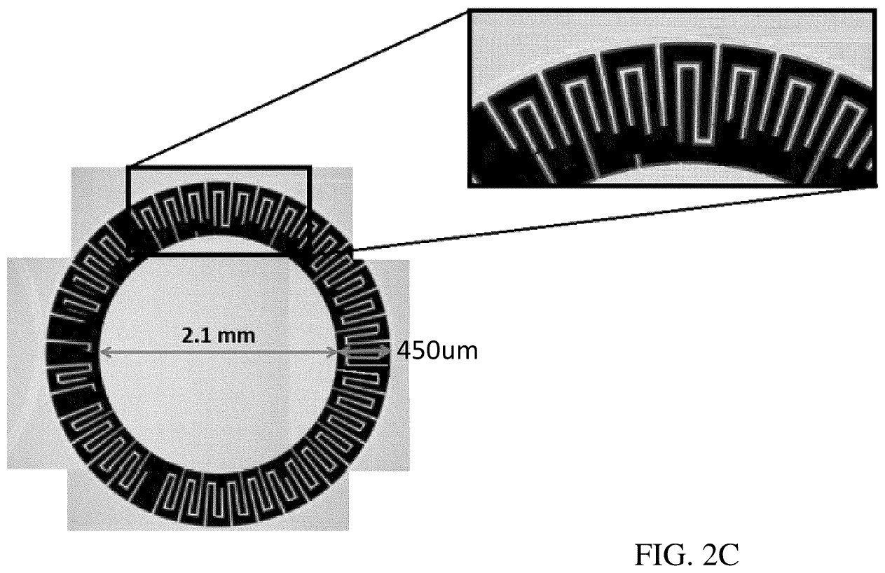

The designed layout of one chip (200) is as shown in FIG. 2A. The example chip is approximately 6.5 square millimeters (mm) in size, which can support four or more optical micro-ring resonators (202, 204, 206, 208) each with radius of approximately 0.5 mm, corresponding to an optical free spectrum range (FSR) of around 30 GHz. Two resonators (204, 206) include released proof masses (i.e., suspended proof masses) (212, 214), while the other two resonators (202, 208) include unreleased proof masses (210, 216) (i.e., unsuspended proof masses, or otherwise solidly formed central bodies without springs or vertical displacement), serving as reference. The resonators (204, 206) having released proof masses (212, 214) include oxide springs (218, 220, respectively) that support the proof masses (212, 214).

One example of such a fabricated chip (300) based upon example chip (200) is shown in FIG. 2B. The entire chip (300) may be glued or otherwise fixed on top of a metal frame (302) which can function as a heat sink. A first optical fiber (304) is attached to one chip edge to transmit a light signal into the chip (300) through a first edge coupling, and a second optical fiber (306) is attached to another chip edge to transmit a light signal out of the chip (300). The coupling loss per facet is smaller than 3 dB. The fibers (304, 306) may also be glued or otherwise positionally fixed onto the metal frame (302) to provide improved mechanical stability.

The spring configuration of the released devices is shown in FIG. 2C. The diameter of the center mass is 2.1 mm, and the length of the spring is 450 micrometers (μm). A portion of the springs are configured to separate to accommodate the mechanical displacement of the proof mass and by result of the built-in stress within the oxide membrane. More particularly, the serpentine spring releases partially in response to the built-in stress, the spring of which shows a higher yield than the straight spring.

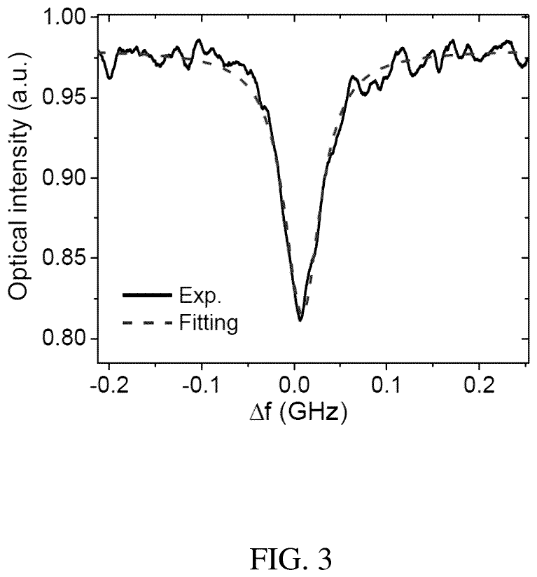

Example results showing optical resonance is shown in FIG. 3. The optical linewidth is only 47 MHz which indicates a loaded optical quality factor “Q” of four million. The optical resonance is measured for the released device which shows much similar Q with the unreleased device, showing the optical Q does not degrade due to the release process, as the optical waveguide is fully cladded within the SiO₂ membrane. The high optical Q would allow high sensitivity and resolution due to the steep slope of the resonance. The optical resonator is over-coupled which leads to shallow resonance dip with 0.8 transmission at the center. However, critical coupling may be preferred for higher sensitivity which can be achieved by increasing the bus waveguide to optical micro-ring coupling gap.

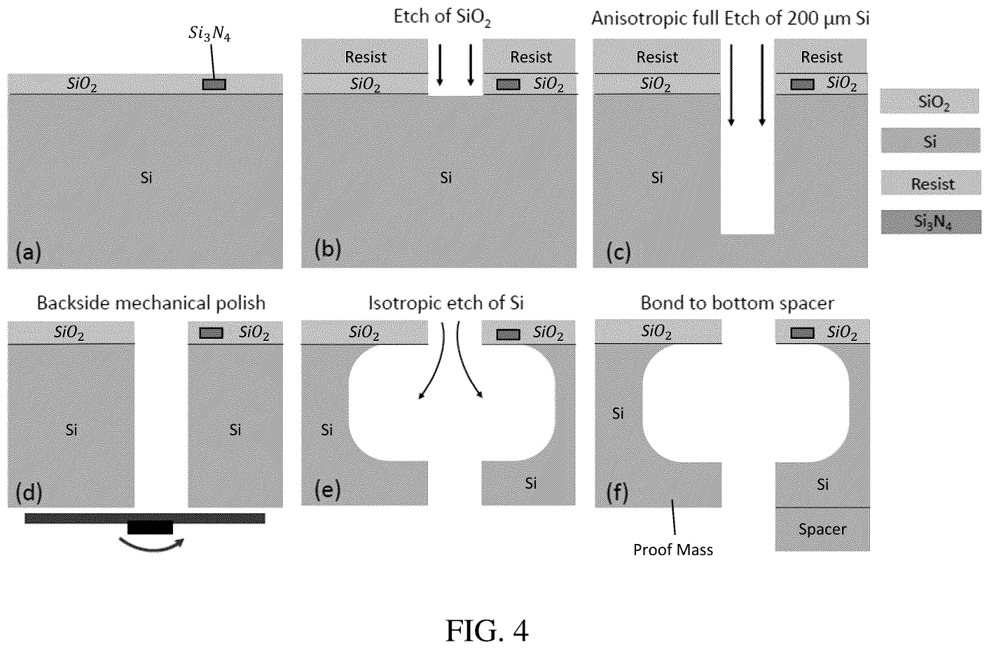

FIG. 4 shows an exemplary method of fabricating an optomechanical accelerometer based on Si₃N₄ optical micro-ring resonator. The method starts with integrating a silicon nitride photonic wafer within an oxide material (e.g., silicon dioxide), such as by using a photonic Damascene process (see, part (a)). Then the silicon dioxide material is patterned and etched, such as by Deep Reactive Ion etching (DRIE), for defining the silicon dioxide cantilever springs (see, part (b)). Next, the method includes deep silicon etching, such as by using the Bosch process for defining the proof mass (see, part (c)). The DRIE of silicon also defines the edges and size of the chip. Then the backside of the wafer is mechanically polished until reaching the silicon DRIE trenches (see, part (d)). This will dice the wafer into chips. Each chip will then undergo Si isotropic etching, such as by using the sulfur hexafluoride (SF₆) to fully release the silicon dioxide spring and the proof mass (see, part (e)). Finally, the chip can optionally be bonded to a silicon spacer to fully suspend the proof mass and prevent it from contacting the bottom substrate (see, part (f)).

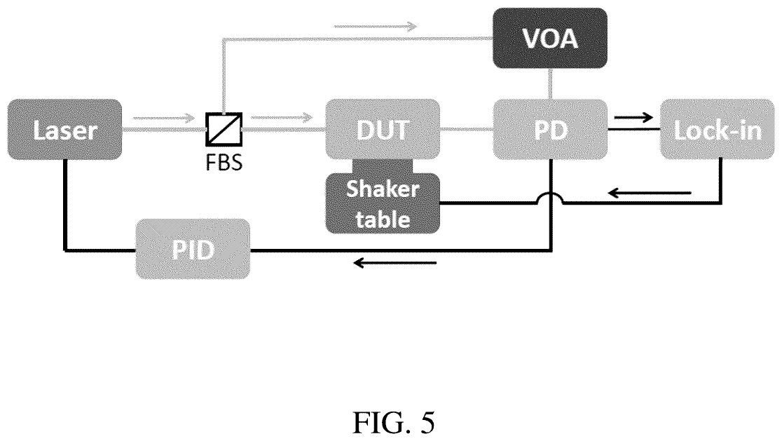

One exemplary optomechanical accelerometer measurement setup is shown in FIG. 5. The output of a light source, shown as a laser, is split into two paths using the fiber beam splitter (FBS). One path works as the reference and its intensity is controlled by a variable optical attenuator (VOA) for balancing the intensity of the two paths. The other path is input into the optomechanical accelerometer. These two paths are finally injected into the balanced photodetector (PD) which will take the difference between the two paths to cancel the intensity fluctuation of the laser. The device under test (DUT) is placed on top of a shaker table which will vibrate at certain frequencies for applying external acceleration. The shaker table is driven by the oscillator of the lock-in amplifier. The output signal of the photodetector is measured and analyzed by the lock-in amplifier. The photodetector signal is also sent back through a PID controller for stabilizing the laser frequency near the slope of the optical resonance. A commercial Analog Devices accelerometer (ADXL) is placed near the DUT on the same shaker table for calibrating the acceleration applied on the device.

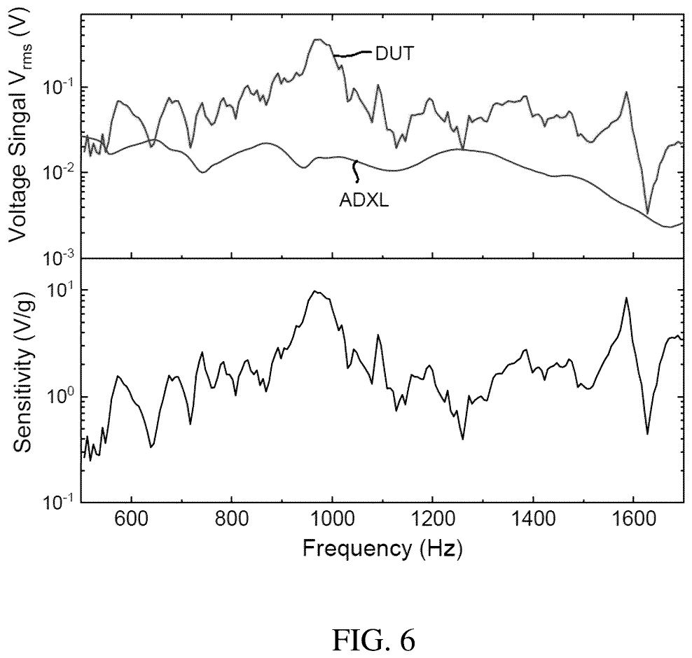

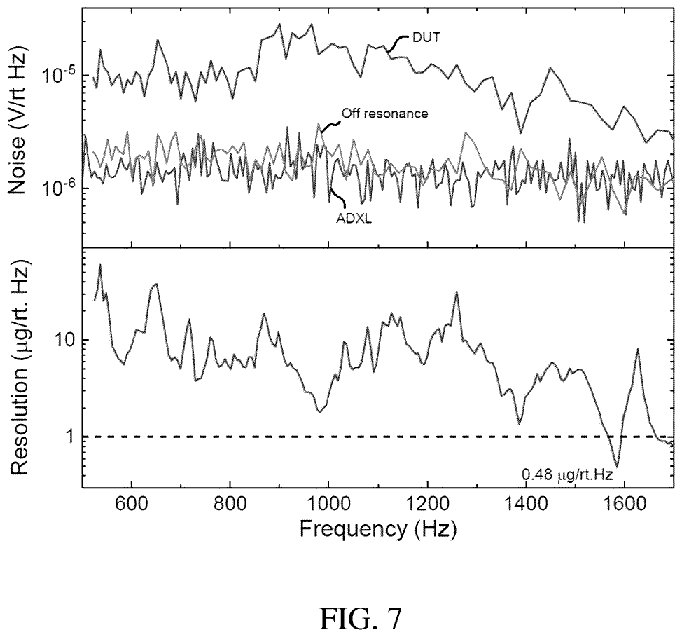

FIG. 6 (top) shows the directly measured raw output voltage signals from the photodetector of the DUT and the ADXL. The DUT shows much higher signal than the ADXL. A mechanical resonance at 1.58 kHz can be clearly resolved, corresponding to the fundamental mechanical mode of the released proof mass. By knowing the sensitivity of the ADXL is 0.4 V/g from its datasheet, the sensitivity of the DUT is calculated as shown in FIG. 6 (bottom). Maximum of 10 V/g is achieved at the mechanical resonance. The noise of the voltage signals from the DUT and ADXL are both measured by turning off the drive for the shaker table, as shown in FIG. 7 (top). It can be seen the described device shows nearly one order of magnitude higher noise than the ADXL at frequencies smaller than 1.2 kHz. The noise gradually decreases as frequency increases and approaches the noise level of the ADXL. To identify the noise sources, the noise when the laser is far off the optical resonance is measured which is similar as the ADXL. This indicates the measurement system itself is with low noise. The resolution of the described optomechanical accelerometer is calculated by normalizing the noise by the sensitivity, as shown in FIG. 7 (bottom). At frequencies below 1.2 kHz, the resolution is on the order of 10 μg/√Hz. As the noise decreases at higher frequency, the resolution increases. It is noteworthy that the resolution is well below 1 μg/√Hz on the mechanical resonance with 480 ng/√Hz.

Besides reading out the acceleration through the modulation of the output light intensity as demonstrated above, there are other advanced schemes that can be supported by this platform which could make the system more compact, low noise, and more sensitive. Examples of such schemes will be described in greater detail below.

By coupling an integrated semiconductor laser with a high optical Q micro-ring resonator, the laser linewidth can be largely suppressed through self-injection locking (SIL), where the reflected light from the optical micro-ring resonator locks the laser to the optical resonance. Upon self-injection locking, the laser frequency will follow with the optical resonance of the micro-ring resonator. This method paves the way for fully integrated laser with performance on par with (or even beyond) bulky fiber lasers.

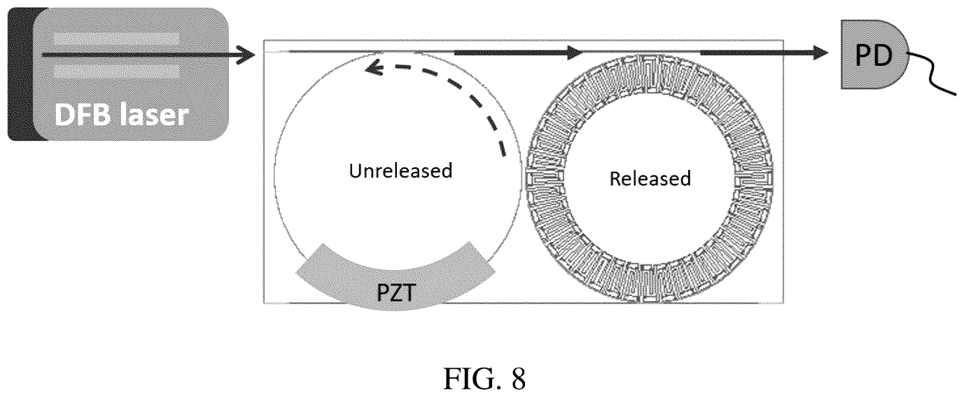

By combining the SIL laser with the optomechanical accelerometer, the whole measurement system shown in FIG. 5 can be fully integrated at the chip-scale, as shown in FIG. 8. On the same chip, optical micro-ring resonators are fabricated including both released and unreleased resonators. The DFB laser may be self-injection locked to the unreleased ring resonator, and the output of it is injected into the released resonator for sensing the external acceleration by measuring the output light intensity. In that sense, the laser may be biased at the slope of the resonance of the released micro-ring resonator. Tuning of the SIL laser frequency over one free spectra range (FSR) has been accomplished by tuning the optical resonance via a piezoelectric actuator made from PZT. Thus, the same PZT actuator may be integrated on the unreleased micro-ring resonator to align the laser frequency with the resonance of the second, released resonator. Similar PID control can be applied in this application to stabilize the relative detune but in a more compact form. The advantage of the co-integration is that the released and unreleased micro-rings experience the same thermal instability such that the thermal noise of the laser can be largely suppressed. Therefore, the described scheme enables a fully integrated optomechanical accelerometer with compact size and low thermal noise.

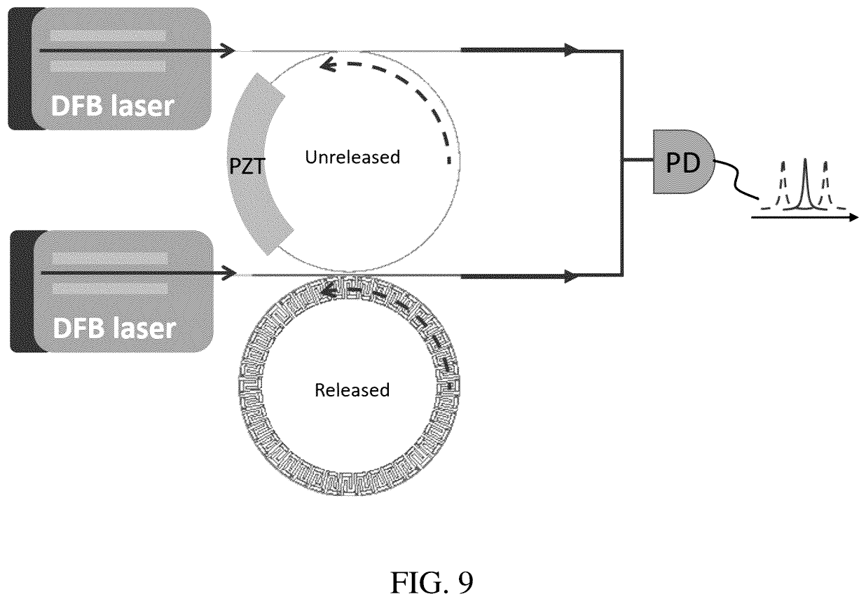

The scheme proposed in FIG. 8 may be relied on for the detection of the modulation of light intensity. However, another exemplary scheme may be utilized having two SIL lasers, as shown in FIG. 9. One laser may be locked to an unreleased optical micro-ring resonator, while the other laser is locked to the released micro-ring resonator. Upon external acceleration, the optical resonance of the released ring will shift, which also tunes the corresponding SIL laser frequency. As the unreleased optical ring serves as a reference, by taking the beat-note between the two SIL lasers, the acceleration can be detected and determined by measuring the shifting of the frequency of the output beat signal. One advantage of this frequency detection is the high signal to noise ratio, which is relatively immune to the intensity fluctuation from the environment. With laser linewidth as low as 1 Hz and the sensitivity of 10 MHz/g, the acceleration resolution can be as low as 100 ng. Also, the beating between the released and unreleased resonators can act to cancel the thermal fluctuations, working as the role of the balanced photodetector used in the aforementioned bulky setup. Integrating a PZT actuator on top of the unreleased resonator is optional and can be used for fine tuning the detune between the resonant frequencies of the two optical resonators. For example, the frequency difference can be tuned to align with a narrow bandwidth RF filter to reject noise outside of the bandwidth. Also, PID controlling can be introduced to stabilize the relative detune through the PZT actuator over long term.

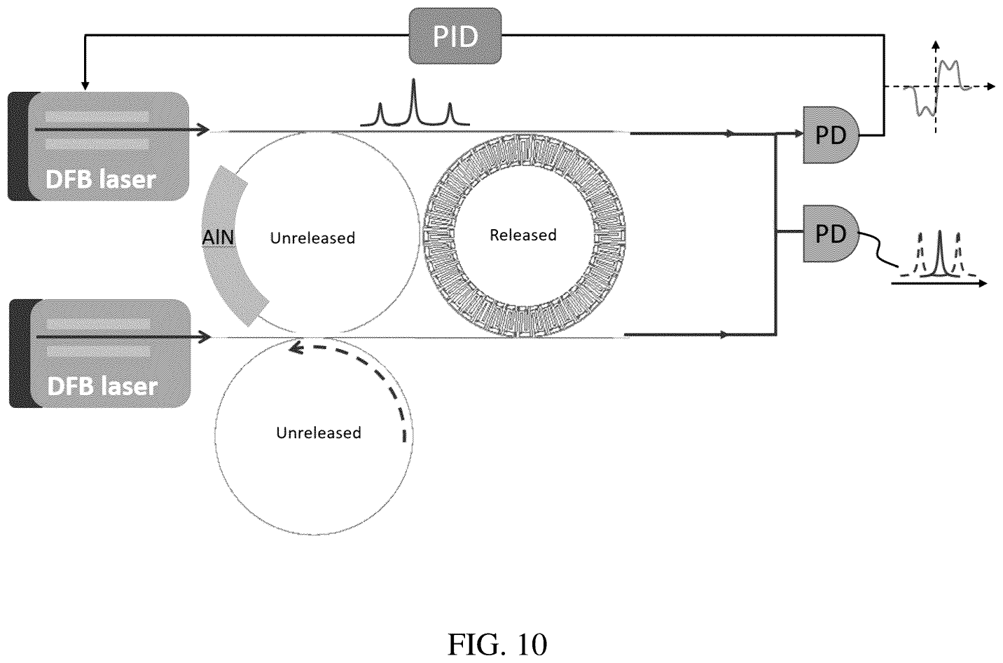

Instead of self-injection locking the laser to the optical resonator, another system can include Pound-Drever-Hall (PDH) locking. As shown in FIG. 10, the upper laser is first injected into the unreleased optical micro-ring resonator, which modulates the light through the High-overtone Bulk Acoustic Wave Resonances (HBAR) excited by the AlN piezoelectric actuator integrated on top. This acousto-optic modulation generates sidebands which are injected into the released accelerometer. Part of the output from the accelerometer is measured by a photodetector. By mixing the beat-note between the sidebands and the carrier and the local oscillator, an error signal can be obtained. Through a PID controller, the upper laser can be locked to the resonance of the released optical resonator of the accelerometer. On the other hand, the lower laser is SIL locked to the unreleased reference optical resonator. Similar as the scheme of FIG. 9, the acceleration can be measured by taking the beating between the output of the two lasers. It will show similar advantages as the scheme of two SIL lasers.

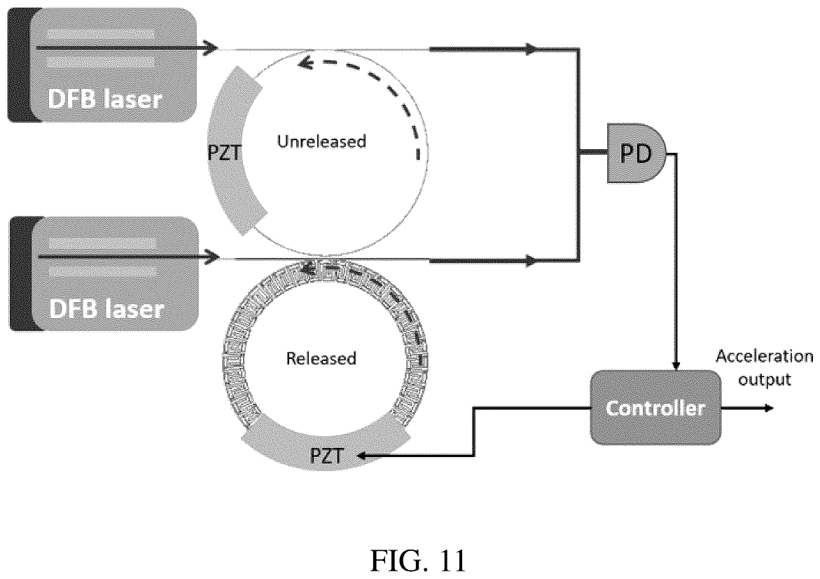

FIG. 11 shows an additional example scheme which incorporates a second closed loop (with the first closed loop being the self-injection locking of the lasers). Similar as the two SIL lasers scheme of FIGS. 9-10, two DFB lasers are also locked to each of the released and unreleased optical resonators. The beat-note of the two SIL lasers is measured by a photodetector. The difference of this scheme is that the output of the beat-note is sent to a controller. The resonant frequency of the released optical resonator is tuned by an integrated PZT actuator and controlled by the controller. Initially the resonant frequency of the two optical resonators may be tuned to be the same. Upon external acceleration, the frequency of the released optical micro-ring resonator will shift, which generates a beat-note signal on the photodetector. The beat-note signal is then sent to controller which produces a feedback voltage signal for controlling the PZT actuator on the released resonator such that the resonant frequency of the two optical resonators align with each other again and the beat-note signal is diminished. The acceleration can be then determined from the feedback signal applied on the PZT actuator.

Described herein is an integrated optomechanical accelerometer based on one or more photonic micro-ring resonators. The acceleration resolution is as high as 480 ng/√Hz at the mechanical resonance of 1.58 kHz. By combining with squeezed light source, the resolution can be further increased beyond the standard quantum limit. Different from previous optomechanical accelerometers, which commonly detect the displacement of the optical mirror, the design described herein relies on the sensing of stress generated by the displacement of the proof mass. The fabrication of the accelerometer is therefore compatible with current CMOS foundry process which enables large scale production. This is especially helpful for dark matter detection which can require an array of accelerometers on the order of 10⁹. Accordingly, the described optomechanical accelerometer may be a practical solution for wide-scale applications including inertial navigation systems, automobiles, consumer electronics, and many more.

Additionally, a plurality of fully integrated schemes is described herein which may utilize a SIL semiconductor laser. Such schemes provide a feasible way for chip-scale integration, and also support narrow linewidth lasers from self-injection locking to high-Q optical resonators. By integrating released and unreleased optical resonators on the same chip, low thermal instability can be achieved by determining the optical intensity differentials of the output optical signals between the two resonators. By introducing another SIL laser, heterodyne detection can be realized through the beat-note between the two SIL lasers. As an alternative to SIL lasers or in combination with SIL lasers, an input laser can be locked to the optical resonator through PDH locking by taking advantage of the acousto-optic modulation on a AlN-on-SiN platform. Finally, a dual closed loop scheme is described where the beat-note signal is feedback to a PZT actuator for tuning the resonant frequency of the released resonator of the accelerometer for balancing the shifting from the external acceleration. Accordingly, the acceleration can be determined from the balancing signal.

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used in combination with some or all of the features of other embodiments as would be understood by one of ordinary skill in the art, whether or not explicitly described as such. One or more exemplary embodiments have been shown and described, and all changes and modifications that come within the spirit of the disclosure are desired to be protected.

I/We claim:

1. An optomechanical accelerometer, comprising:
(a) a first ring resonator defining a perpendicular axis centrally therethrough, wherein the first ring resonator defines an optical resonant frequency;
(b) a proof mass movable along the perpendicular axis; and
(c) one or more springs coupling the proof mass with the first ring resonator, wherein the one or more springs are configured to selectively stretch or contract when the proof mass is mechanically displaced along the perpendicular axis to generate stress or strain adjacent to the first ring resonator;
wherein mechanical displacement of the proof mass is operable to modify the optical resonant frequency of the first ring resonator.

2. The optomechanical accelerometer of claim 1, wherein the first ring resonator is formed from a plurality of integrated silicon nitride photonic circuits.

3. The optomechanical accelerometer of claim 1, wherein the first ring resonator is fully embedded within a host material.

4. The optomechanical accelerometer of claim 3, wherein the host material includes an oxide material.

5. The optomechanical accelerometer of claim 3, further comprising:
(a) a first optical fiber coupled with the host material, wherein the first optical fiber is configured to provide an input optical signal to the host material; and
(b) a second optical fiber coupled with the host material, wherein the second optical fiber is configured to output a resultant optical signal from the first ring resonator.

6. The optomechanical accelerometer of claim 5, further comprising a piezoelectric actuator selectively operable to adjust the frequency of the input optical signal.

7. The optomechanical accelerometer of claim 5, further comprising a distributed feedback laser operable to generate the input optical signal.

8. The optomechanical accelerometer of claim 7, further comprising a second ring resonator, wherein the input optical signal from the distributed feedback laser is configured to be self-injection locked (SIL) to the second ring resonator, wherein the second ring resonator is configured to output a SIL optical signal toward the first ring resonator.

9. The optomechanical accelerometer of claim 5, further comprising a photodetector coupled with the second optical fiber, wherein the photodetector is configured to measure a light intensity of the resultant optical signal.

10. The optomechanical accelerometer of claim 1, wherein the one or more springs include oxide springs.

11. A method of fabricating an accelerometer, comprising:
(a) depositing a photonic layer over a silicon material layer;
(b) etching a pattern within the photonic layer;
(c) etching the pattern deeper through a portion of the silicon material layer to form a trench;
(d) polishing a backside surface of the silicon material layer; and
(e) isotropically etching the silicon material layer.

12. The method of claim 11, further comprising embedding an optical waveguide within the photonic layer.

13. The method of claim 11, wherein the photonic layer is formed of silicon dioxide and silicon nitride.

14. The method of claim 11, wherein etching a pattern within the photonic layer includes a photonic Damascene procedure.

15. The method of claim 11, wherein etching the pattern deeper through a portion of the silicon material layer includes a Bosch process.

16. The method of claim 11, wherein isotropically etching the silicon material layer includes separating the photonic layer and silicon material layer into two unattached components.

17. The method of claim 16, further comprising bonding the backside surface of one component of the two unattached components to a spacer to thereby suspend a proof mass.

18. An optomechanical accelerometer, comprising:
(a) a ring resonator defining a perpendicular axis centrally therethrough, wherein the ring resonator is formed from a plurality of integrated silicon nitride photonic circuits and defines an optical resonant frequency;
(b) one or more springs configured to couple a proof mass with the ring resonator, wherein the one or more springs are configured to selectively stretch or contract when the proof mass is mechanically displaced along the perpendicular axis to generate stress or strain adjacent to the ring resonator, wherein mechanical displacement of the proof mass is operable to modify the optical resonant frequency of the ring resonator;
(c) a first optical fiber configured to provide an input optical signal to the ring resonator; and
(d) a second optical fiber configured to output a resultant optical signal from the ring resonator.

19. The optomechanical accelerometer of claim 18, wherein the ring resonator is fully embedded within an oxide material.

20. The optomechanical accelerometer of claim 18, further comprising a piezoelectric actuator selectively operable to adjust the frequency of the input optical signal.
